(19) United States
(12) Patent Application Publication
(10) Pub. No.: US 2014/0024239 A1
(43) Pub. Date: Jan. 23, 2014

(54) CONNECTOR

(71) Applicant: Yazaki Corporation, Tokyo (JP)

(72) Inventors: Masahiro TANAKA, Kakegawa-shi (JP); Hajime KATO, Kakegawa-shi (JP)

(73) Assignee: Yazaki Corporation, Tokyo (JP)

(21) Appl. No.: 14/037,971

(22) Filed: Sep. 26, 2013

Related U.S. Application Data
(63) Continuation of application No. PCT/JP2012/063416, filed on May 18, 2012.

(30) Foreign Application Priority Data
May 20, 2011 (JP) 2011-113929

(51) Int. Cl. H01R 13/52

(52) U.S. Cl. CPC H01R 13/5205
USPC 439/271

(57) ABSTRACT

A connector includes a housing having a terminal insertion hole, a terminal that is inserted into the terminal insertion hole, an O ring that is attached so as to surround a periphery of the terminal and blocks a gap between the terminal insertion hole and the terminal, a fastener for fastening and fixing a mating terminal to the terminal, and an O ring holder that is pressed toward the O ring by the fastener and pushes the O ring toward the gap between the terminal insertion hole and the terminal.

### CROSS REFERENCE TO RELATED APPLICATIONS

This application is a continuation of PCT application No. PCT/JP2012/063416, which was filed on May 18, 2012 based on Japanese Patent Application (No. P2011-113929) filed on May 20, 2011, the contents of which are incorporated herein by reference.

### BACKGROUND OF THE INVENTION

1. Field of the Invention

The present invention relates to a connector having a structure in which liquid such as water or oil is prevented from penetrating the inside of a housing of the connector.

2. Description of the Related Art

A connector having a liquid penetration preventive structure in which liquid such as water or oil is prevented from penetrating the inside of a housing of the connector is known conventionally (for example, see JP-A-2006-92779).

This connector includes a housing 1, a terminal 2 and an O ring 3 as shown in FIG. 5. A terminal insertion hole 4 is formed in the housing 1, and the terminal 2 is inserted into this terminal insertion hole 4. The O ring 3 is attached to this terminal 2, and this O ring 3 is received in an O ring receiving step part 5 formed in the housing 1. Then, this connector prevents the liquid from penetrating the inside of the housing 1 by the O ring 3.

### SUMMARY OF THE INVENTION

However, the connector with the structure described above is not provided with a structure in which removal of the O ring 3 is prevented, and the O ring 3 is held by being only fitted into the O ring receiving step part 5 of the housing 1. As a result, when vibration or a shock is applied to the connector, there is fear that the O ring 3 is dropped off from the O ring receiving step part 5 and a good waterproof effect is not obtained.

Also, the connector described above does not have a structure in which wiring of the connection mating side is fastened to the terminal 2 to make sure connection.

The invention has been implemented in view of the circumstances described above, and an object of the invention is to provide a connector capable of maintaining a good liquid penetration preventive effect and surely connecting wiring.

In order to achieve the object described above, a connector according to the invention is characterized by the following (1) to (3).

(1) A connector includes a housing having a terminal insertion hole, a terminal that is inserted into the terminal insertion hole, an O ring that is attached so as to surround a periphery of the terminal and blocks a gap between the terminal insertion hole and the terminal, a fastener for fastening and fixing a mating terminal to the terminal, and an O ring holder that is pressed toward the O ring by the fastener and pushes the O ring toward the gap between the terminal insertion hole and the terminal.
(2) For example, an O ring attachment recess portion which communicates with the terminal insertion hole is formed in the housing, and the O ring is fitted into the O ring attachment recess portion.
(3) For example, the O ring holder has a ring part into which the terminal can be inserted, and the ring part presses the O ring over the periphery of the terminal.
(4) For example, a rib portion is formed on an outer circumference of the O ring, and a recess corresponding to the rib portion in shape is formed on the O ring attachment recess portion.

In the connector with the configuration of the above (1), the mating terminal is fastened to the terminal by the fastener and thereby, a state of sure connection to wiring of the connection mating side can be obtained and connection reliability can be improved. Also, the gap between the terminal insertion hole and the terminal is sealed with the O ring which is attached so as to surround the whole periphery of the terminal and blocks the gap between the terminal insertion hole and the terminal, and liquid such as water or oil can be prevented from penetrating the inside of the housing. Further, the O ring holder which is pressed to the O ring side by the fastener for fastening the mating terminal to the terminal and pushes the O ring toward the gap between the terminal insertion hole and the terminal is included, so that fastening of the mating terminal to the terminal and removal prevention of the O ring can be implemented collectively, and both connection reliability and a good waterproof effect can be maintained surely.

In the connector with the configuration of the above (2), the O ring is maintained in a state of being pressed by the O ring holder to be fitted into the O ring attachment recess portion, so that a state in which the gap between the terminal insertion hole and the terminal is well sealed with the O ring can be ensured.

In the connector with the configuration of the above (3), the O ring is pressed by the ring part of the O ring holder over the periphery of the terminal with equally, so that the state in which the gap between the terminal insertion hole and the terminal is better sealed with the O ring can be ensured.

In the connector with the configuration of the above (4), the O ring is tightly fitted with the O ring attachment recess portion, so that the O ring is prevented from dropping off from the O ring attachment recess portion.

According to the invention, the connector capable of maintaining a good liquid penetration preventive effect and surely connecting wiring can be provided.

The invention has been described above briefly. Further, the details of the invention will become more apparent by reading through a mode for carrying out the invention described below with reference to the accompanying drawings.

### BRIEF DESCRIPTION OF THE DRAWINGS

FIG. 1 is a perspective view of a connector according to an embodiment.

FIG. 2 is a perspective view of a part of a structure of a connection of the connector in section view.

FIG. 3 is a sectional view in the connection of the connector.

FIG. 4 is a perspective view of a part of a housing of the connector in the connection of the connector in section view.

FIG. 5 is a sectional view describing a structure of a conventional connector.

### DETAILED DESCRIPTION OF THE EXEMPLARY EMBODIMENTS

An example of an embodiment according to the invention will hereinafter be described with reference to the drawings.

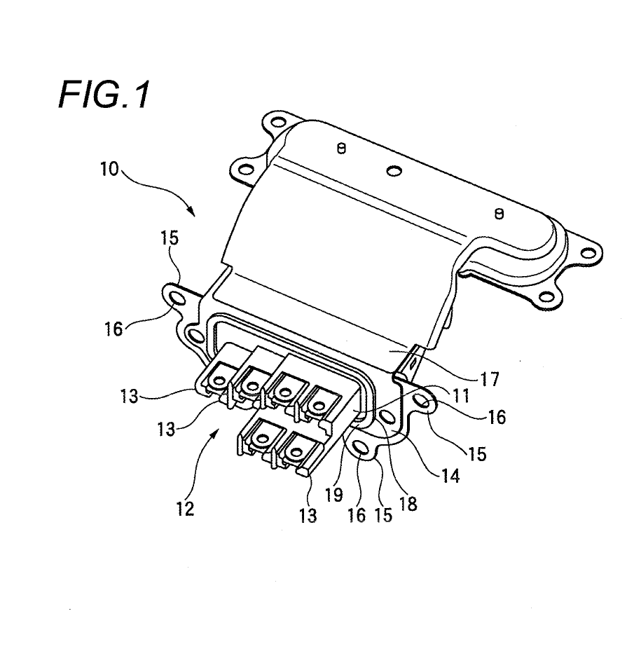

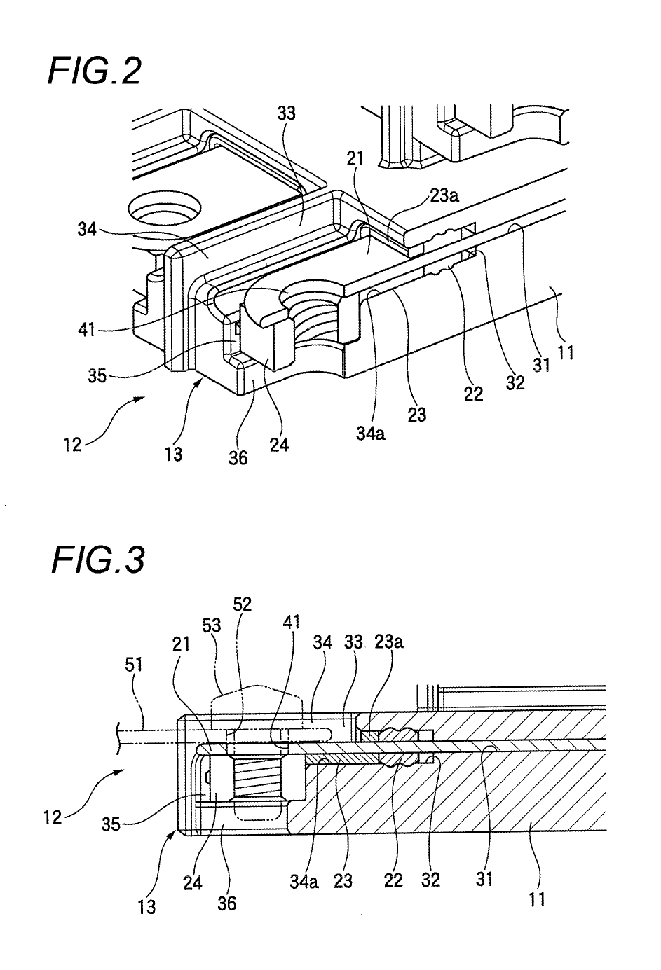

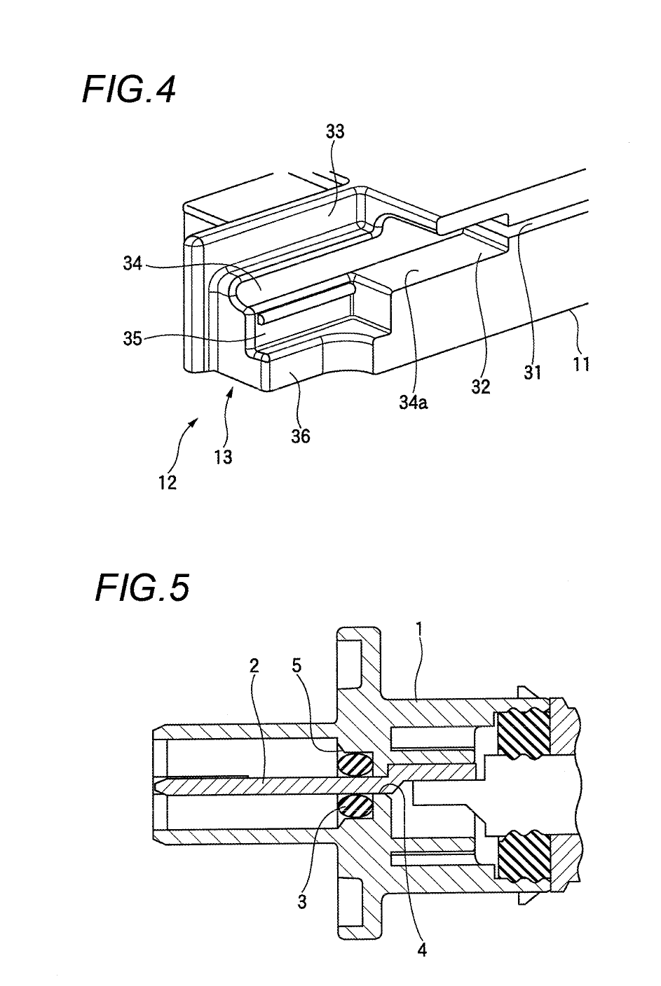

FIG. 1 is a perspective view of a connector according to the embodiment, and FIG. 2 is a perspective view of a part of a structure of a connection of the connector in section view, and FIG. 3 is a sectional view in the connection of the connector, and FIG. 4 is a perspective view of a part of a housing of the connector in the connection of the connector in section view.

As shown in FIG. 1, a connector 10 is attached to, for example, a panel of various devices.

This connector 10 has a housing 11 molded of an insulating synthetic resin etc. The attachment side of this housing 11 to the panel is provided with a connection 12, and this connection 12 is provided with plural terminal blocks 13. A part of this housing 11 is covered with a shell 17.

In the housing 11, the connection 12 is provided with a flange part 14 projecting to the periphery. Plural fixing pieces 15 overhanging outward are formed in this flange part 14, and insertion holes 16 are formed in these fixing pieces 15.

Also, a seal groove 18 is formed in the flange part 14 so as to surround the periphery of the terminal blocks 13, and annular packing 19 is fitted into this seal groove 18.

In the case of attaching this connector 10 to the panel of various devices, the terminal blocks 13 of the connection 12 of the housing 11 are inserted into attachment holes (not shown) formed in the panel, and the flange part 14 is abutted on a surface of the panel in the edge of the attachment holes. In this state, screws (not shown) are inserted into the insertion holes 16 of the fixing pieces 15 and are screwed into screw holes (not shown) formed in the panel.

Consequently, the connector 10 is fixed and attached to the panel. Also, when the connector 10 is fixed to the panel thus, the packing 19 makes close contact with the panel to form a seal between the panel and the connector 10.

Next, the terminal blocks 13 formed on the connection 12 of the housing 11 will be described.

As shown in FIGS. 2 and 3, the terminal block 13 includes a terminal 21, an O ring 22, an O ring holder 23, and a fastening nut (fastener) 24.

As shown in FIG. 4, a terminal insertion hole 31 is formed in the housing 11 in the connection 12. Also, the front side beyond the terminal insertion hole 31 in the housing 11 is provided with an O ring attachment recess portion 32 communicating with the terminal insertion hole 31 by forming a hole with a cross-sectional area larger than that of the terminal insertion hole 31.

Also, the front side beyond the O ring attachment recess portion 32 in the housing 11 is provided with a fastening part 34 whose upper side is opened by forming a notch 33. An engaging recess 35 is formed in the fastening part 34, and a clearance groove 36 is formed in the bottom of this engaging recess 35.

A rib portion is formed on an outer circumference of the O ring 22 and extends in a circumference direction of the O ring 22. A recess or groove corresponding to the rib portion in shape is formed on the O ring attachment recess portion 32.

Then, the terminal 21 formed of a conductive metal material such as copper is inserted into the terminal insertion hole 31 in the connection 12 of the housing 11. A fastening hole 41 is formed in the end of this terminal 21, and this fastening hole 41 is arranged in the fastening part 34.

The annular O ring 22 is attached to the terminal 21 inserted into the terminal insertion hole 31 from the distal end side of the terminal 21. This O ring 22 is formed of an elastic material such as rubber, and is attached to the terminal 21 so as to surround the whole periphery of the terminal 21. This O ring 22 is fitted into the O ring attachment recess portion 32, and a gap between the terminal 21 and the terminal insertion hole 31 into which the terminal 21 is inserted is sealed with the O ring 22.

Also, the O ring holder 23 with a plate shape is fitted between the terminal 21 and a bottom surface 34a of the fastening part 34. This O ring holder 23 is formed of a synthetic resin or a metal material, and a ring part 23a into which the terminal 21 can be inserted is formed at one end of the O ring holder 23 which is located at a side of the O ring 22. Then, the ring part 23a is abutted on the O ring 22 fitted into the O ring attachment recess portion 32 by pushing the O ring holder 23 toward the O ring 22 with the terminal 21 inserted into this ring part 23a.

Also, the fastening nut 24 made of a square nut is fitted into the engaging recess 35 of the fastening part 34 from the distal end side of the housing 11, and the O ring holder 23 is pushed toward the O ring attachment recess portion 32 by this fastening nut 24.

As shown in FIG. 3, a mating terminal 51 of the other device side is connected to the terminal 21 of the fastening part 34 constructed as described above. An insertion hole 52 is formed in this mating terminal 51. In the case of connecting this mating terminal 51 to the terminal 21, the mating terminal 51 is stacked on the terminal 21 so that the insertion hole 52 communicates with the fastening hole 41 of the terminal 21.

In this state, a fastening screw (fastener) 53 is inserted into the insertion hole 52 of the mating terminal 51 and the fastening hole 41 of the terminal 21, and is screwed and fastened into the fastening nut 24. In addition, the distal end of the fastening screw 53 projecting from the lower portion of the fastening nut 24 is held inside the clearance groove 36 formed in the bottom of the engaging recess 35 without interfering with the housing 11.

This strongly connects the mating terminal 51 to the terminal 21 by a fastening force of the fastening nut 24 and the fastening screw 53 to obtain sure connection reliability.

Also, when the fastening screw 53 is fastened to the fastening nut 24 thus, the fastening nut 24 is surely fixed. Then, the O ring holder 23 pushed toward the O ring attachment recess portion 32 by this fastening nut 24 is held. Consequently, the O ring 22 is maintained in a state of being pushed toward the O ring attachment recess portion 32 over the whole periphery by the ring part 23a of the O ring holder 23, and removal is prevented. Therefore, the terminal insertion hole 31 into which the terminal 21 is inserted is maintained in a state of being surely sealed with the O ring 22.

According to the connector according to the embodiment thus, the mating terminal 51 is fastened to the terminal 21 by the fastening nut 24 and the fastening screw 53 and thereby, a state of sure connection to wiring of the connection mating side can be obtained and connection reliability can be improved.

Also, a gap between the terminal insertion hole 31 and the terminal 21 is sealed with the O ring 22 which is attached so as to surround the periphery of the terminal 21 and blocks the gap between the terminal insertion hole 31 and the terminal 21, and liquid such as water or oil can be prevented from penetrating the inside of the housing 11 from the device side. Further, the O ring holder 23 which is pressed toward the O ring 22 by the fastening nut 24 and the fastening screw 53 for fastening the mating terminal 51 to the terminal 21 and pushes the O ring 22 toward the gap between the terminal insertion hole 31 and the terminal 21 is included, so that fastening of the mating terminal 51 to the terminal 21 and removal prevention of the O ring 22 can be implemented collectively, and both connection reliability and a good waterproof effect can be maintained surely.

Also, the O ring 22 is maintained in a state of being pressed by the O ring holder 23 to be fitted into the O ring attachment recess portion 32, so that a state in which the gap between the terminal insertion hole 31 and the terminal 21 is well sealed with the O ring 22 can be ensured.

Further, the O ring 22 is pressed by the ring part 23a of the O ring holder 23 over the whole periphery of the terminal 21 with equally, so that the state in which the gap between the terminal insertion hole 31 and the terminal 21 is better sealed with the O ring 22 can be ensured.

In addition, the invention is not limited to the embodiment described above, and modifications, improvements, etc. can be made properly. Moreover, as long as the invention can be achieved, the number of components, materials, shapes, dimensions, arrangement places, etc. of each of the components in the embodiment described above are arbitrary and are not limited.

By the above configurations, the connector capable of maintaining a good liquid penetration preventive effect and surely connecting wiring can be obtained.

What is claimed is:

1. A connector, comprising:
a housing having a terminal insertion hole;
a terminal that is inserted into the terminal insertion hole;
an O ring that is attached so as to surround a periphery of the terminal and blocks a gap between the terminal insertion hole and the terminal;
a fastener for fastening and fixing a mating terminal to the terminal; and
an O ring holder that is pressed toward the O ring by the fastener and pushes the O ring toward the gap between the terminal insertion hole and the terminal.

2. The connector according to claim 1, wherein an O ring attachment recess portion which communicates with the terminal insertion hole is formed in the housing; and
wherein the O ring is fitted into the O ring attachment recess portion.

3. The connector according to claim 1, wherein the O ring holder has a ring part into which the terminal can be inserted; and
wherein the ring part presses the O ring over the periphery of the terminal.

4. The connector according to claim 2, wherein a rib portion is formed on an outer circumference of the O ring; and
wherein a recess corresponding to the rib portion in shape is formed on the O ring attachment recess portion.

5. The connector according to claim 3, wherein a rib portion is formed on an outer circumference of the O ring; and
wherein a recess corresponding to the rib portion in shape is formed on the O ring attachment recess portion.
